(19) United States
(12) Patent Application Publication
(10) Pub. No.: US 2011/0311116 A1
(43) Pub. Date: Dec. 22, 2011

(54) SYSTEM AND METHODS FOR ANATOMICAL STRUCTURE LABELING

(75) Inventor: Douglas K. Benn, Omaha, NE (US)

(73) Assignee: Creighton University, Omaha, NE (US)

(21) Appl. No.: 13/162,925

(22) Filed: Jun. 17, 2011

Related U.S. Application Data
(60) Provisional application No. 61/355,710, filed on Jun. 17, 2010.

(51) Int. Cl. G06K 9/00

(52) U.S. Cl. 382/128

(57) ABSTRACT

An imaging system and methods for processing a two-dimensional image from three-dimensional image information is disclosed. Images are segmented into foreground regions and background regions. An object-centered coordinate system is created and a hierarchical anatomical model is accessed to classify object in order to identify an anatomical object. The anatomical text labels are generated and positioned on the image slices and at least one image slice is displayed.

This application claims the benefit of U.S. Provisional Application Ser. No. 61/355,710, filed Jun. 17, 2010, the disclosure of which is hereby incorporated by reference in its entirety.

### FIELD OF THE INVENTION

The present invention relates generally to imaging, and more specifically to medical imaging and the automatic labeling of anatomical structures to identify radiographic anatomy in medical scans and further to assist in teaching radiographic anatomy of a subject. Anatomical structures are identified in a two-dimensional image, wherein the two-dimensional image is generated from three-dimensional image information. Specifically, the two-dimensional image is an image slice of a three-dimensional object.

### BACKGROUND

Medical imaging has influenced many aspects of modern medicine. The availability of volumetric images from imaging modalities such as X-ray computed tomography (“CT”), magnetic resonance imaging (“MRI”), three-dimensional (“3D”) ultrasound, and positron emission tomography (“PET”) has led to an increased understanding of biology, physiology, and human anatomy, as well as facilitated studies in complex disease processes.

Medical imaging is particularly suited to dentistry. Unlike medical primary care providers, dentists have traditionally been their own radiographers and radiologists. In the early stages of dental medical imaging, dentists produced and interpreted intraoral radiographs restricted to the teeth and the supporting alveolar bone. With the introduction of dental panoramic tomography (“DPT”), the volume of tissue recorded radiographically significantly increased, for example, from the hyoid bone to the orbits in the axial plane and from the vertebral column to the mandibular menton in the coronal plane.

Advances in medical imaging introduced cone beam computed technology (“CBCT”). CBCT is advantageous over DPT because it provides more information. With DPT, there is one image slice of the area of interest, while CBCT produces up to 512 image slices in each axial, saggital, and coronal planes generating a total of 1,536 image slices for the area of interest. CBCT may also produce 120 reformatted image slices of the jaw, which may be reviewed by a dentist in order to assist with a medical procedure such as positioning implants.

One difficulty for dentists when switching from DPT to CBCT is that the volume of tissue is generally much larger since the tissue can extend from the vertex of the skull to the larynx and from the tip of the nose to the posterior cranial fossa. Additionally, dentists using CBCT require knowledge of hard tissue anatomy of the skull, face, jaw, vertebrae, and upper neck region in order to interpret image slices effectively. Moreover, it is expected that advances in CBCT may further require dentists to increase their knowledge of soft tissue detail in reviewing image slices in order to fully diagnose a patient.

Another difficultly for dentists when switching from DPT to CBCT is the skill required to interpret disorders other than common dental diseases from review of the image slices. In review of CBCT images for diagnosing oral and maxillofacial disorders, dentists may fail to detect abnormalities in the total radiographic volume captured by the CBCT exam. CBCT image slices may not only be used in identifying dental diseases, but also disorders such as developmental, vascular, metabolic, infections, cysts, benign and malignant tumors, obstructive sleep apnea, and iatrogenic diseases such as bisphosphonate related osteo-necrosis of the jaw.

Medical imaging is constantly improving, particularly in the field of virtual three-dimensional models of internal anatomical structures. Such three-dimensional models can be rotated and viewed from any perspective and anatomically labeled. However, these models require human interaction.

There is a need for an anatomical recognition system and methods that do not require human interaction and that can automatically identify anatomical structures within an image slice. Furthermore, there is a need for an automatic anatomical recognition process to train and educate medical practitioners in diagnosing disorders and other diseases. There is also a need for image libraries that can be used with anatomical recognition system and methods. The present invention satisfies these needs.

### SUMMARY OF THE INVENTION

The present invention is directed to an anatomical recognition system and methods that identifies anatomy in a two-dimensional image, specifically an image slice of a three-dimensional object. For purposes of this application the term “two-dimensional image” and “image slice” are used interchangeably herein. The two-dimensional image is extracted from three-dimensional image information such as physical data of an image scan of a subject. The two-dimensional image is usually one of a stack of two-dimensional images which extend in the third dimension. Two or more two-dimensional images or image slices are referred to herein as a “data set”.

The system and methods automatically identify anatomical structure. Specifically, anatomical structure is displayed as a closed area on an image slice, otherwise referred to herein as an “anatomical object”. More specifically, when an anatomical object is identified in an image slice, the object is automatically identified in all image slices of the data set. For purposes of this application, image slices are generated by cone beam computed technology (“CBCT”), but any technology for generating image slices is contemplated. An advantage of using CBCT is that up to 512 image slices can be produced in each of the axial, saggital, and coronal planes providing a total of 1,536 image slices for a three-dimensional object.

The anatomical recognition system and methods according to the present invention may be used as a teaching tool to train and educate practitioners in identifying anatomical structures, which may further assist in reading images and diagnosing conditions such as disorders and other diseases. Although the present invention is discussed herein with respect to medical applications and anatomy of the head of a subject, the present invention may be applicable to the anatomy of any portion of the subject, for example, temporomandibular joints, styloid processes, paranasal air sinuses, and oropharynx including epiglottis, valleculae, pyrifrom recesses and hyoid bone.

It is further contemplated the present invention may be used in various applications such as geology, botany, and veterinary to name a few. For example, the anatomical recognition system and methods of the present invention may also be applicable to fossil anatomy, plant anatomy, and animal anatomy, respectively.

The anatomical recognition system and methods processes a two-dimensional image generated from three-dimensional image information. More specifically, a data set of one or more image slices is generated from a three-dimensional object. Each image slice is divided into two or more image regions. Specifically, the image slice is segmented into foreground regions and background regions. An object-centered coordinate system is created for each image slice, although it is contemplated that the coordinate system may be created for the data set. A hierarchical anatomical model is accessed from within a database to automatically identify anatomical structure, specifically anatomical objects on an image slice. Once the anatomical object is identified on the image slice, a text label is generated and positioned in the image slice.

The hierarchical anatomical model is accessed to classify an unclassified or unrecognized anatomical object in order to identify the anatomical object on the image slice. The hierarchical anatomical model includes anatomical structure and its corresponding anatomical object. Again, an anatomical object is the closed area of the anatomical structure on the image slice. In one embodiment, the anatomical object may be an organ, tissue, or cells that may be identified on the image slice. It is also contemplated that the anatomical object may be pictures or diagrams that may be identified on the image slice.

In particular, the anatomical structure and its corresponding anatomical object of the hierarchical anatomical model may include geometric properties of anatomical structures, knowledge of 3D relationships of anatomical objects, and rule-based classification of anatomical objects previously identified on an image slice. Anatomical objects may be classified or recognized on the image slice using geometric properties or a priori knowledge of 3D anatomy. The anatomical object may further be defined by voxels and geometric properties of the anatomical structure of the three-dimensional image information. The hierarchical anatomical model is utilized to correctly identify the anatomical object on the image slice.

A hierarchical anatomical model may be implemented with gray level voxels at the lowest level and English or other language text label at the highest level. Intermediate levels may have geometric properties of segmented anatomical structures. The hierarchical model is a computer representation of the various abstractions of information from the low level gray to the high level semantic text.

The hierarchical anatomical model according to the present invention is dynamic and can automatically identify similar anatomical structures and corresponding anatomical objects in different data sets. For example, an anatomical object identified by the text label “Left mandibular coronoid process” in one data set can be automatically identified in a different data set.

Any anatomical objects that are not recognized are considered unclassified. The unclassified anatomical objects are then classified using an artificial intelligence algorithm that attempts to recognize (classify) anatomical objects by first identifying high confidence objects and then using these objects to assist in classifying more objects. It is contemplated that the algorithm may conduct multiple attempts to classify the anatomical object on the image slice. Upon classification of anatomical objects, it is identified on the image slice of the data set. The anatomical object is automatically identified in all image slices of the data set upon identifying the anatomical object on an image slice. A text label is then generated and positioned on the image slice. The text label may be positioned in all image slices of the data set. The image slice is illustrated on a display including the text label.

In embodiments where the anatomical recognition system and methods is implemented as a teaching tool, a menu driven graphical user interface allows a user to initially label anatomical structures to create a training library for subsequent testing of a student. The training library is also available for testing the automatic recognition method. In the interactive creation mode of the training library, as each anatomical object in the slice is identified by the user, this information is used to assist in creating the hierarchical anatomical model. In the teaching mode, the hierarchical anatomical model is referenced to determine if the student being tested for anatomical knowledge has correctly identified the anatomical object being sought in an image slice.

The graphical user interface may include an anatomical selection window configured for the user to select a particular anatomical structure. The graphical user interface may also include an interactive image slice window which displays image slices of the data set. The user selects a point on one of the image slices of the anatomical structure to identify an anatomical object. A text label is generated and positioned on the image slice. When the text label is positioned on the image slice, the label is automatically positioned in all image slices of the data set identifying the anatomical object.

Additionally, the graphical user interface may include a reference window configured to display reference anatomical diagrams. The graphical user interface may also have an example window illustrating labeling of one or more anatomical regions.

The present invention compiles images to create a library or database that can be used for verifying the accuracy of automatic anatomical recognition systems, specifically the accuracy of the identification of a particular anatomical object. The database may include the hierarchical anatomical model including anatomical structure and its corresponding anatomical object. In order to verify the accuracy of the recognition system, the identity of the anatomical object as determined by the user is compared against the identity of the object as recorded in the library. The library or database may include the three-dimensional image information, extracted two-dimensional image, image slices, anatomical objects including X, Y, and Z coordinates (such as 4, 17, 37 identifying the position of the mental foramen of the jaw), text label (such as “R Mental Foramen”), and Foundational Model of Anatomy ID number (such as “276249”). The library may also include the pixel coordinates defining the position of the anatomical object on the two-dimensional image or image slice. It is also contemplated that the graphical user interface can track activities of the user. For example, a text window may appear on the graphical user interface that provides a log of the user's past actions and current activity.

The described embodiments are to be considered in all respects only as illustrative and not restrictive, and the scope of the invention is not limited to the foregoing description. Those of skill in the art will recognize changes, substitutions and other modifications that will nonetheless come within the scope of the invention and range of the claims.

### BRIEF DESCRIPTION OF THE DRAWINGS

The preferred embodiments of the invention will be described in conjunction with the appended drawings provided to illustrate and not to the limit the invention, where like designations denote like elements, and in which:

FIG. 1 is a block diagram illustrating an anatomical recognition system according to one embodiment of the invention;

FIG. 2 is a flow chart of certain steps according to one embodiment of the present invention;

FIG. 3 is a flow chart illustrating additional steps of the classifying step of FIG. 2;

FIG. 4 is an exemplary graphical user interface according to one embodiment of the invention; and

FIG. 5 is an exemplary cloud computer system used to implement the methods according to the present invention.

### DETAILED DESCRIPTION OF THE INVENTION

The present invention is directed to an imaging system 100 for labeling anatomical information on an image. The two-dimensional images may be CBCT images, however CT images or MRI images are also contemplated.

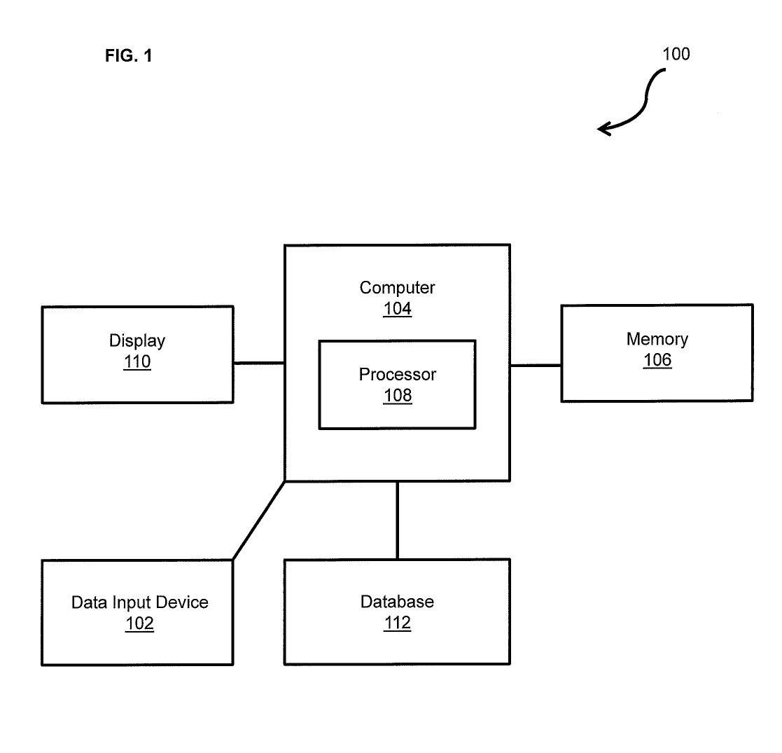

A block diagram of the anatomical recognition system 100 is shown in FIG. 1. One or more images are generated using imaging equipment (not shown) and inputted via a data input device 102 into a computer 104 that includes a memory 106. The data input device 102 may be any computer input device, including a keyboard, mouse, trackball, and scanner, or anything that can transfer the images from the data input device 102 to the computer 104. Images can be transferred directly from the imaging equipment, or alternatively stored in memory 106 of a computer 104 and transferred from the memory 106 to the computer 104. The computer 104 may be any general purpose personal computer (“PC”), server, or computing system including web-based computer systems and applications, such as a tablet PC, a set-top box, a mobile device such as a personal digital assistant, a laptop computer, or any other machine capable of executing a set of instructions (sequential or otherwise) that specify actions to be taken by that machine. Generally, the computer 104 includes a processor 108 that follows one or more sets of computer instructions to perform various computing tasks.

The imaging system 100 includes a display 110 connected to the computer 104 and processor 108. The display is any output device for presentation of information in visual or tactile form, for example, a liquid crystal display (“LCD”), and organic light-emitting diode (“OLED”), a flat panel display, a solid state display, or a Cathode Ray Tube (“CRT”).

The imaging system 100 also has a database 112 or library that may be externally connected to the computer 104 and processor 108. In other embodiments, the database 112 can be internally part of the computer 104 or memory 106. The database 112 may include the hierarchical anatomical model including anatomical structure and its corresponding anatomical object. The database 112 may also include three-dimensional relationships of the anatomical objects, and rule-based classifications of anatomical objects using image properties or three-dimensional spatial properties.

The processor 108 segments one or more images received by the computer 104 from the data input device 102 into foreground regions and background regions. The processor 108 may further create an object-centered coordinate system for each data set of image slices.

The database 112 may include a hierarchical anatomical model. Preferably, the database 112 includes geometric properties of anatomical structures, information of three-dimensional relationships of anatomical structures, and additional information related to rule-based classification of anatomical objects using image properties and three-dimensional spatial properties. The three-dimensional spatial properties are both coordinate positions of an anatomical object and relationships of the object to other surrounding anatomical objects. Image properties include object area, greyness, disperseness, and edge gradient.

As an example, the following three-dimensional relationship may be stored in the database 112 pertaining to the anatomical structure of the left maxillary sinus: 1) located to the left of the nasal cavity; 2) located above the hard plate/floor of the nose; 3) located below the orbital floor; and 4) located to the right of the cheek skin. An exemplary rule-base classification of anatomical objects of the left maxillary sinus may be based on whether or not the anatomical structure: 1) is air filled; 2) has a volume X cubic centimeters; 3) has a position relative to six anatomical structures that contain the sinus region; and 4) has image features of greyness, edge gradient, and disperseness.

A hierarchical anatomical model may be implemented with gray level voxels at the lowest level and English or other language text label at the highest level. Intermediate levels may have geometric properties of segmented anatomical structures. The computer 104 determines which voxels form the geometric properties of an anatomical structure. The anatomical structure can be matched to the corresponding anatomical object using the voxels. When an unknown or unclassified object is matched to a certain voxels of a known object within the database, the object is recognized or classified.

Voxels are small 3D cubes with numerical values relating to and image scan. Each image scan is made up of millions of voxels stacked up in the X, Y, and Z coordinate directions identifying the detail of anatomical structure. A text label such as “L maxillary sinus” may be at the highest level because it is represented by a few hundred thousand voxels. For example, when information is extracted from the physical data of the image scan—three-dimensional image information—and converted to a two-dimensional image including a text label, the transition is made from high level information to low level information of the image slice.

Any anatomical objects that are not recognized are considered unclassified. The unclassified anatomical objects are then classified using an artificial intelligence algorithm that attempts to recognize (classify) anatomical objects by first identifying high confidence objects and then using these objects to assist in classifying more objects. It is contemplated that the algorithm may conduct multiple attempts to classify the anatomical object on the image slice.

Upon classification of anatomical objects, the processor 108 identifies the object on the image slice of the data set. A text label is generated and positioned on the image slice. The processor 108 then automatically identifies the anatomical object in all image slices of the data set. At least one image slice is illustrated on the display 110 including text labels.

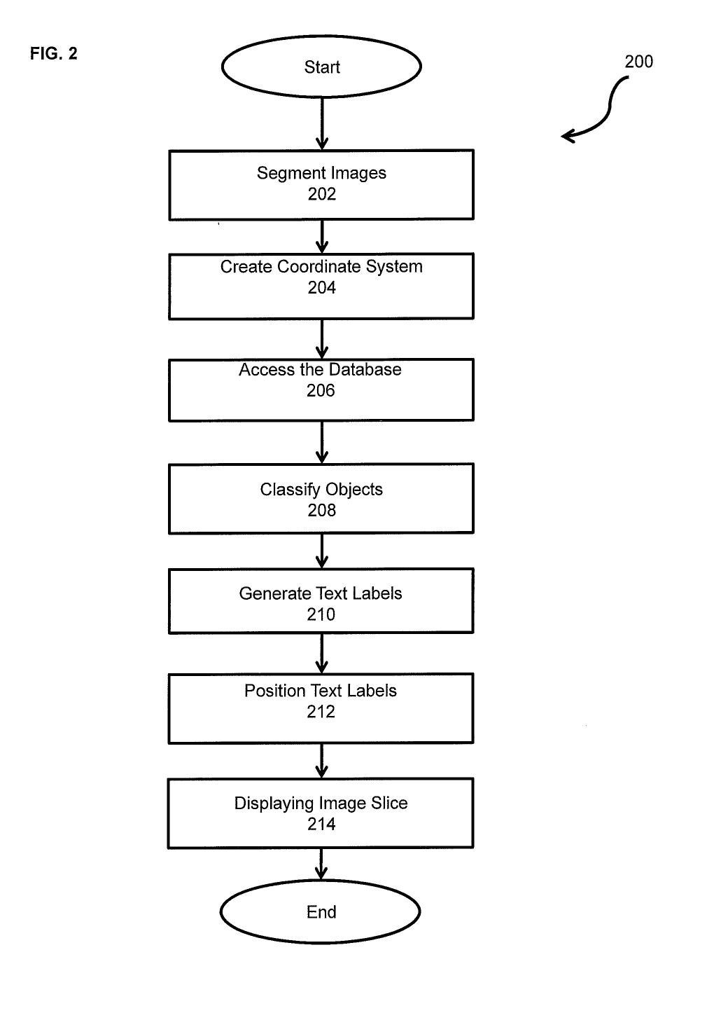

FIG. 2 is a flow chart 200 of certain steps according to one embodiment of the present invention. Specifically, FIG. 2 illustrates the automatic processing of two-dimensional images from three-dimensional image information. The computer 104 stores into memory 106 a data set of image slices. The processor 108 first segments the images received by the computer 104 into foreground regions and background regions at Step 202. The processor 108 then proceeds to create an object-centered coordinate system for each image slice of the data set at Step 204.

In Step 206, the processor 108 accesses a database 112 to reference a hierarchical anatomical model. The processor 108 proceeds to classify unclassified objects of the data sets at Step 208 to identify anatomical object on the image slice. Upon identifying the anatomical objects, text labels are generated at Step 210 and positioned on the image slice of each data set at Step 212. The processor 108 then proceeds to display at least one image slice of the data set at Step 214.

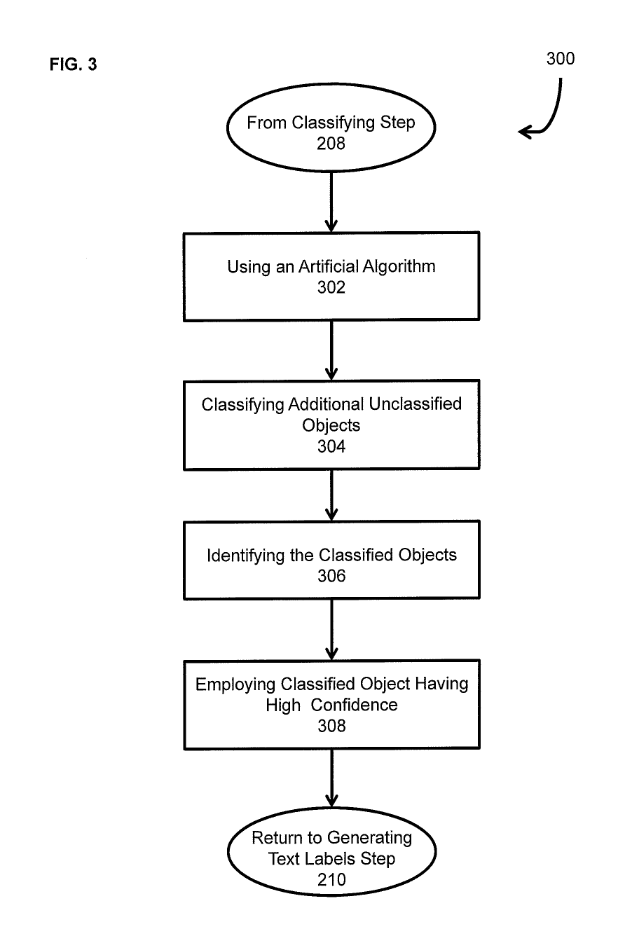

FIG. 3 illustrates a flow chart 300 of additional steps to the classifying step 208 of FIG. 2. An artificial intelligence algorithm to classify at least one of the unclassified objects occurs at Step 302. The artificial intelligence algorithm uses knowledge of anatomical structure and the location of anatomical objects in image slices to reduce the number of possibilities in classifying an unclassified object. In other words, the algorithm limits or filters the number of possible choices available for an unclassified object based on relationships of classified objects.

Attempts are made to classify additional unclassified objects at step 304. Preferably, Step 304 occurs multiple times to ensure accurate classification of unclassified objects. The classifying step further includes a step of identifying the classified objects having a high confidence at Step 506. In order to determine whether a high confidence exists, the number of possible matches between an unknown object and a candidate set of possible objects is calculated. In one embodiment, possible matches are calculated based on the number of features or characteristics of an unclassified object that match a classified object in the hierarchical anatomical model. The calculation may result in a confidence score or percentage score to indicate the probability of an exact match. For example, a confidence score of 0% means a low probability of an exact match and 100% means a high probability of an exact match. At Step 308, the classified objects having a high confidence are employed to assist in classifying additional unclassified objects.

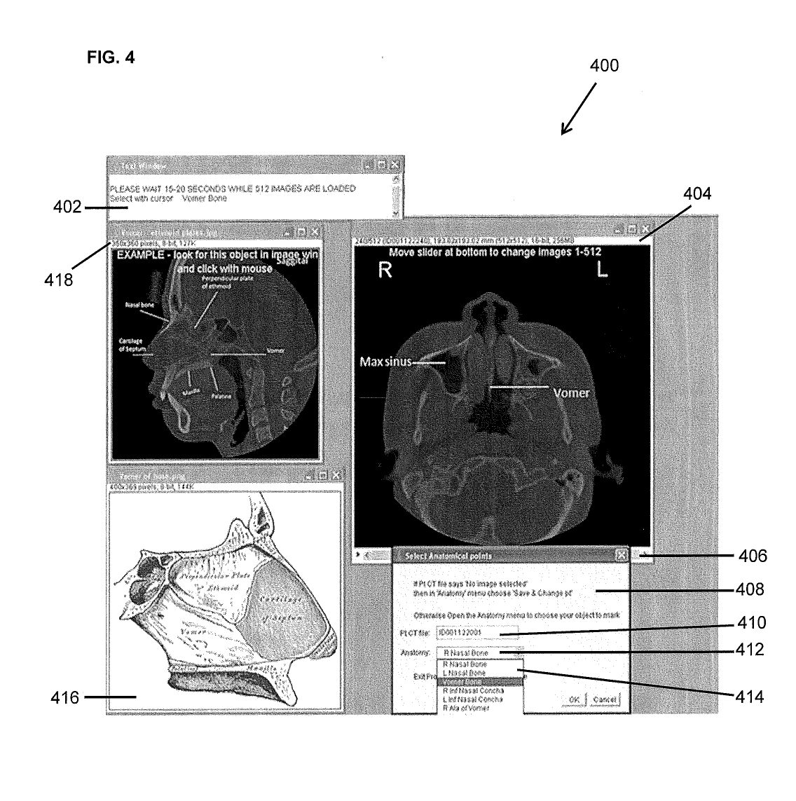

FIG. 4 shows one exemplary graphical user interface 400 according to one embodiment of the invention. The graphical user interface 400 provides users with a platform for labeling anatomical structure in an image slice. The anatomical recognition system and methods according to the present invention may be used as a teaching tool to train and educate practitioners in identifying anatomical structures, which may further assist in diagnosing disorders and other diseases.

The graphical user interface 400 includes multiple windows that facilitate labeling of one or more sets of two-dimensional images from three-dimensional image information. Labeling of image slices can be performed automatically by the imaging system 100 or interactively by a user based on user input. The graphical user interface 400 of FIG. 4 allows user inputs to identify various anatomical structures on image slices of a data set.

As shown in FIG. 4, the graphical user interface 400 includes a “text” window 402. The text window 402 may provide information to the user about the status of the imaging system 100 and further track activities of a user. The text window 402 may also include details on the description of images loaded into a window, as well as a description of an anatomical structure. For example, the text window 402 can inform a user of a time period before images are loaded into an interactive “image slice” window 404.

The image slice window 404 displays image slices from a data set. In the embodiment as shown, the interactive image slice window 404 has an image slice which shows the vomer bone loaded within the window 404. This is one slice of 512 images and each slice which contains the vomer bone is labeled. Each image slice can be viewed using a slider 406 located at the bottom of the image slice window 404. It is further contemplated that the image slices may include the designations “R” and “L” to communicate the orientation to the user.

The graphical user interface 400 further includes a “select anatomical points” window 408 that is configured for user selection of a specific anatomical structure. Upon selection of a file from a “file” window box 410, an “anatomy” window box 412 is available that includes a pull-down menu 414 providing a variety of text labels identifying anatomical structure for selection. As shown, the pull-down menu 414 includes the anatomical structure: R Nasal Bone, L Nasal Bone, Vomer Bone, R Inf Nasal Concha, L Inf Nasal Concha, R Ala of Vomer, etc.

Once a user selects the anatomical structure to be labeled in the image slice window 404, a cross-hair (not shown) appears in the image slice window 404. Selection of the text label of the anatomical structure from the pull-down menu 414 may further cause the anatomical points window 408 to disappear. The user may navigate the cross-hair to different locations of the image slice shown in the image slice window 404 and select its position using an input device 102. The position selected by the user prompts insertion of an anatomical object on the image slice, specifically the text label of the anatomical structure selected from the pull-down menu 414. FIG. 4 shows “Vomer” and “Max sinus” anatomical objects applied as text labels in the image slice window 404.

The graphical user interface 400 further may include a “reference” window 416 that illustrates diagrams or pictures such as from textbooks, journals, encyclopedias, or surgical procedures. It is contemplated that an anatomical structure may include several diagrams. For example, for the ethmoid sinus air cells there may be left and right air cells in three groups—anterior, middle, and posterior—resulting in six different diagrams that may be displayed. An “example” window 418 may further illustrate the correct labeling of anatomical structures.

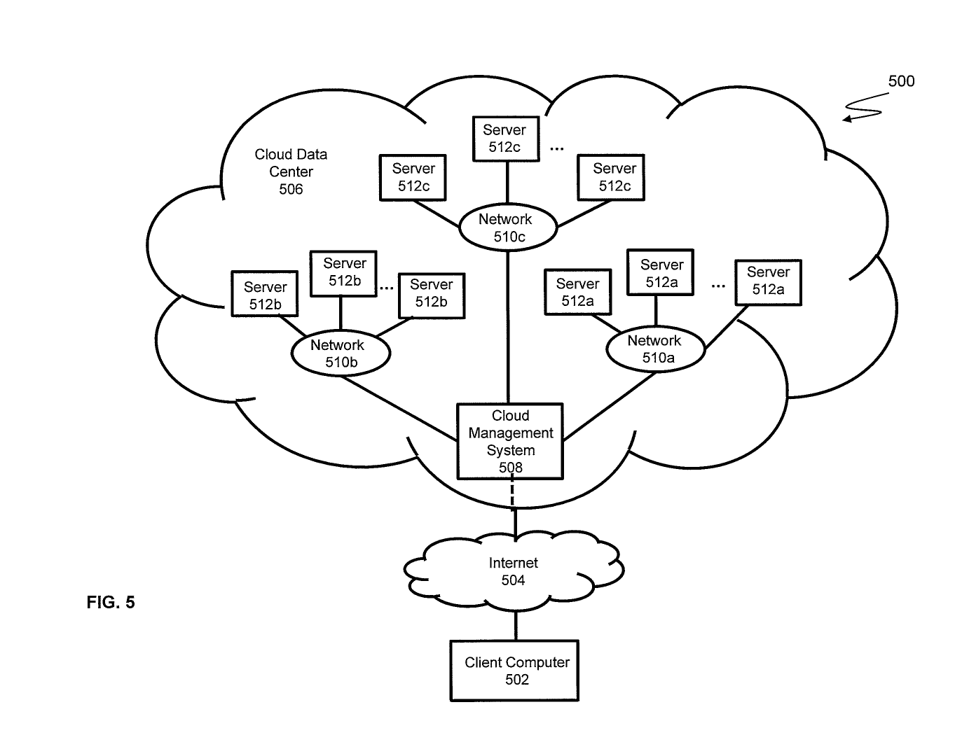

With the advent of cloud computing, it is contemplated that anatomical recognition system and methods of the present invention may be implemented on a cloud computing system. FIG. 5 illustrates an exemplary cloud computing system 500 that may be used to implement the methods according to the present invention. The cloud computing system 500 includes a plurality of interconnected computing environments. The cloud computing system 500 utilizes the resources from various networks as a collective virtual computer, where the services and applications can run independently from a particular computer or server configuration making hardware less important.

Specifically, the cloud computing system 500 includes at least one client computer 502. The client computer 502 may be any device through the use of which a distributed computing environment may be accessed to perform the methods disclosed herein, for example, a traditional computer, portable computer, mobile phone, personal digital assistant, tablet to name a few. The client computer 502 includes memory such as random access memory (“RAM”), read-only memory (“ROM”), mass storage device, or any combination thereof. The memory functions as a computer usable storage medium, otherwise referred to as a computer readable storage medium, to store and/or access computer software and/or instructions.

The client computer 502 also includes a communications interface, for example, a modem, a network interface (such as an Ethernet card), a communications port, a PCMCIA slot and card, wired or wireless systems, etc. The communications interface allows communication through transferred signals between the client computer 502 and external devices including networks such as the Internet 504 and cloud data center 506. Communication may be implemented using wireless or wired capability such as cable, fiber optics, a phone line, a cellular phone link, radio waves or other communication channels.

The client computer 502 establishes communication with the Internet 504—specifically to one or more servers—to, in turn, establish communication with one or more cloud data centers 506. A cloud data center 506 includes one or more networks 510a, 510b, 510c managed through a cloud management system 508. Each network 510a, 510b, 510c includes resource servers 512a, 512b, 512c, respectively. Servers 512a, 512b, 512c permit access to a collection of computing resources and components that can be invoked to instantiate a virtual machine, process, or other resource for a limited or defined duration. For example, one group of resource servers can host and serve an operating system or components thereof to deliver and instantiate a virtual machine. Another group of resource servers can accept requests to host computing cycles or processor time, to supply a defined level of processing power for a virtual machine. A further group of resource servers can host and serve applications to load on an instantiation of a virtual machine, such as an email client, a browser application, a messaging application, or other applications or software.

The cloud management system 508 can comprise a dedicated or centralized server and/or other software, hardware, and network tools to communicate with one or more networks 510a, 510b, 510c, such as the Internet or other public or private network, with all sets of resource servers 512a, 512b, 512c. The cloud management system 508 may be configured to query and identify the computing resources and components managed by the set of resource servers 512a, 512b, 512c needed and available for use in the cloud data center 506. Specifically, the cloud management system 508 may be configured to identify the hardware resources and components such as type and amount of processing power, type and amount of memory, type and amount of storage, type and amount of network bandwidth and the like, of the set of resource servers 512a, 512b, 512c needed and available for use in the cloud data center 506. Likewise, the cloud management system 508 can be configured to identify the software resources and components, such as type of Operating System (“OS”), application programs, and the like, of the set of resource servers 512a, 512b, 512c needed and available for use in the cloud data center 506.

The present invention is also directed to computer products, otherwise referred to as computer program products, to provide software to the cloud computing system 500. Computer products store software on any computer useable medium, known now or in the future. Such software, when executed, may implement the methods according to certain embodiments of the invention. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, optical storage devices, Micro-Electro-Mechanical Systems (“MEMS”), nanotechnological storage device, etc.), and communication mediums (e.g., wired and wireless communications networks, local area networks, wide area networks, intranets, etc.). It is to be appreciated that the embodiments described herein may be implemented using software, hardware, firmware, or combinations thereof.

The cloud computing system 500 of FIG. 5 is provided only for purposes of illustration and does not limit the invention to this specific embodiment. It is appreciated that a person skilled in the relevant art knows how to program and implement the invention using any computer system or network architecture.

While the present invention has been described with reference to particular embodiments, those skilled in the art will recognize that many changes may be made thereto without departing from the scope of the present invention. Each of these embodiments and variants thereof is contemplated as falling with the scope of the claimed invention, as set forth in the following claims.

What is claimed is:

1. A method for automatically identifying anatomical information on an image, comprising the steps of:
receiving a data set of two or more image slices generated from a three-dimensional object into a memory of a computer;
segmenting by a processor of the computer one image slice into foreground regions and background regions;
creating by the processor an object-centered coordinate system for the image slice;
accessing a hierarchical anatomical model within a database;
classifying an unclassified object of the image slice using the hierarchical anatomical model to identify at least one anatomical object on the image slice;
generating by the processor a text label;
positioning the text label on the image slice on or near the anatomical object; and
displaying the image slice on a display.

2. The method for automatically identifying anatomical information on an image of claim 1, wherein said classifying step further comprises the step of using an artificial intelligence algorithm to classify at least one of the unclassified objects.

3. The method for automatically identifying anatomical information on an image of claim 2, wherein said classifying step further comprises the step of repeating said using step at least one time to attempt to classify additional unclassified objects.

4. The method for automatically identifying anatomical information on an image of claim 3, wherein said classifying step further comprises the step of identifying the classified objects having a high confidence.

5. The method for automatically identifying anatomical information on an image of claim 4, wherein said classifying step further comprises the steps of employing the classified objects having a high confidence to assist in classifying additional unclassified objects.

6. The method for automatically identifying anatomical information on an image of claim 1, wherein the anatomical object is identified on all image slices of the data set.

7. The method for automatically identifying anatomical information on an image of claim 1, wherein said positioning step further comprises the step of locating the text label on or near the anatomical object on all image slices of the data set.

8. The method for automatically identifying anatomical information on an image of claim 1, wherein the database includes anatomical structure corresponding to the anatomical object.

9. The method for automatically identifying anatomical information on an image of claim 1, wherein the database includes three-dimensional relationships of the anatomical object.

10. The method for automatically identifying anatomical information on an image of claim 1, wherein the database includes rule-based classifications of the anatomical object.

11. The method for automatically identifying anatomical information on an image of claim 10, wherein the rule-based classifications of the anatomical object use three-dimensional spatial properties.

12. The method for automatically identifying anatomical information on an image of claim 1, wherein the hierarchical anatomical model includes gray level voxels.

13. The method for automatically identifying anatomical information on an image of claim 1, wherein the hierarchical anatomical model further includes geometric properties of segmented anatomical objects.

14. The method for automatically identifying anatomical information on an image of claim 1, wherein the image slices are generated from cone beam computed technology.

15. An imaging system for identifying anatomical information on an image, the system comprising:
a database;
a memory;
a display connected to said memory;
a processor connected to said memory and said database; and
a data input device configured to input images of a three-dimensional object into the memory in order to obtain a plurality of image slices;
said processor processing the plurality of image slices to:
segment one image of the plurality into foreground regions and background regions;
create an object-centered coordinate system for the image slice;
access a hierarchical anatomical model from said database;
classify an unclassified object of the image slice using the hierarchical anatomical model to identify at least one anatomical object on the image slice, wherein the anatomical object is identified on all image slices of the data set;
generate a text label;
position the text label on the image slice on or near the anatomical object on the image slice and on all image slices of the data set; and
display at least one image slice on the display.

16. The system for automatically identifying anatomical information on an image of claim 15, wherein the system further comprises a graphical user interface.

17. The system for automatically identifying anatomical information on an image of claim 16, wherein the graphical user interface is configured for a user to select of an anatomical structure.

18. The system for automatically identifying anatomical information on an image of claim 16, wherein the graphical user interface is configured to display reference diagrams.

19. The system for automatically identifying anatomical information on an image of claim 16, wherein the graphical user interface is configured to track activities of a user.

20. The system for automatically identifying anatomical information on an image of claim 16, wherein the graphical user interface is configured to illustrate the correct labeling of anatomical structures.
